(19) United States
(12) Patent Application Publication
(10) Pub. No.: US 2005/0134437 A1
(43) Pub. Date: Jun. 23, 2005

(54) Automated annunciator parameter transfer apparatus and method

(75) Inventor: Raymond J. LeBlanc, Bristol, CT (US)

Correspondence Address: BAKER & HOSTETLER LLP, Washington Square, Suite 1100, 1050 Connecticut Avenue, N.W., Washington, DC, 20036, US

(73) Assignee: Edwards Systems Technology, Inc.

(21) Appl. No.: 10/737,795

(22) Filed: Dec. 18, 2003

(51) Int. Cl. G08B 9/00

(52) U.S. Cl. 340/286.02; 709/220

(57) ABSTRACT

In a system for performing public-address announcing, a software implementable process integrates the functions of a processor equipped with a graphical user interface, a communications interconnection system, one or more dedicated control devices, and a multiplicity of sound emitters. The process allows a user to automatically reconfigure the control devices while maintaining detailed display of status and configuration, thereby obviating manual operations for configuration and control.

### FIELD OF THE INVENTION

The present invention relates generally to annunciator and speaker amplifier systems. More particularly, the present invention relates to systems and processes for automating the programming and operation of annunciators and related apparatus.

### BACKGROUND OF THE INVENTION

Current practice in the operation of annunciator-based, speaker amplifier-based, and similar multiple loudspeaker public address systems typically requires manual configuration. In systems that employ digital controls, configuration still relies on manual entry of the system control station's configuration as well as manual, unit-by-unit transmission of configuration codes from the system control station to distributed receivers. Such manual configuration can be time consuming and error prone. In addition, there are noticeable drawbacks in such areas as the training of users and, as in manually configured systems, there is a tendency to produce errant audible signals.

Accordingly, it is desirable to provide systems and methods that can remove repetitive manual steps from and more fully automate the system configuration and control operations of annunciator and speaker amplifier systems.

### SUMMARY OF THE INVENTION

The foregoing needs are met, to a great extent, by the present invention, wherein in one aspect an apparatus is provided that in some embodiments automates the process of configuring individual annunciators and related public address sound generators by transmitting complete configuration command messages in response to user initiated actions.

In accordance with one embodiment of the present invention, a method of performing configuration modification on an integrated annunciator and control system comprises the steps of activating an event/driver interface process, selecting a unit to be modified, confirming that the selected unit is a system panel, determining the selected unit's address and communication setting, creating a command string for the unit address and communication setting, sending the command string to initialize a network programmer function, inserting a target unit address based on the network programmer function into an address list box, sending a configuration command to an opened communications port, the communication port being connected to a target, polling the target having the target unit address, downloading configuration data from the polled target, modifying and uploading to the selected unit the downloaded configuration data, and closing the network programming function.

In accordance with another embodiment of the present invention, a computer readable medium with program instructions for managing an integrated annunciator and control system comprises the instructions for activating an event/driver interface process, selecting a unit to be modified, confirming that the selected unit is a system panel, determining the selected unit's address and communication setting, creating a command string for the unit address and communication setting, sending the command string to initialize a network programmer function, inserting a target unit address based on the network programmer function into an address list box, sending a configuration command to an opened communications port, the communication port being connected to a target, polling the target having the target unit address, downloading configuration data from the polled target, modifying and uploading to the selected unit the downloaded configuration data, and closing the network programming function.

In accordance with yet another embodiment of the present invention, an integrated annunciator and control system comprises a processing device, a first system monitor and control unit, a first bidirectional communication system interconnecting the processing device and the system monitor and control unit, a first signaling device, a second bidirectional communication system interconnecting the system monitor and control unit and the first signaling device; and a processor-based instruction sequence actuating the processing device to provide control of the first system monitor and control unit and the first signaling device.

In accordance with still another embodiment of the present invention, an integrated annunciator and control system comprises processing means for processing computational information, first emitting means for emitting acoustic signals, first monitoring and controlling means for monitoring and controlling the first emitting means, first communicating means for communicating between the processing means and the first monitoring and controlling means, second communicating means for communicating between the first monitoring and controlling means and the first emitting means; and controlling and actuating means for controlling and actuating the first communicating means and the first emitting means.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are presented for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a system block diagram illustrating an exemplary system according to this invention.

FIG. 2 is a flowchart of an exemplary process of this invention.

FIG. 3 is a screen display illustrating an exemplary initial user view.

FIG. 4 is a screen display illustrating an exemplary second user view.

FIG. 5 is a screen display illustrating a continuation of an exemplary second user view.

### DETAILED DESCRIPTION

The invention will now be described with reference to the drawing figures, in which like reference numerals refer to like parts throughout.

Alternative approaches to configuration and operation of annunciator systems are described in U.S. patent application Ser. No. 10/664,911 titled, “Programmable Event Driver/Interface Apparatus and Method,” filed Sep. 22, 2003, by LeBlanc et al., and U.S. patent application Ser. No. 10/722,096, titled, “System Panel Programmer Apparatus and Method,” filed Nov. 20, 2003, by LeBlanc et al., the contents of which are incorporated herein by reference in their entirety.

The foregoing U.S. patent applications describe among others discrete functions and independent operations for system command and system component configuration. However, greater operational integration and ease of use can be achieved by modifying the command software to include dynamic reconfiguration of programmable devices in the system, as discussed herein.

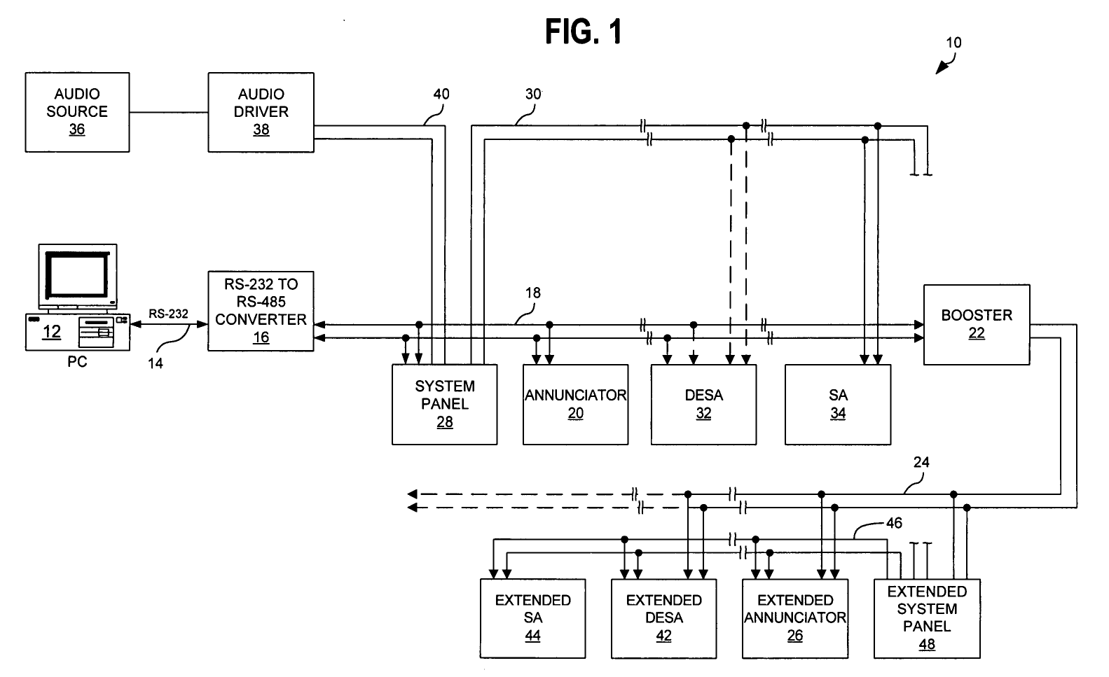

FIG. 1 is a system block diagram illustrating an exemplary hardware configuration 10 in which the exemplary processes of this invention can operate. In the exemplary configuration 10, a standalone programmable controller, such as, for example, a personal computer (PC) 12, is connected via an RS-232 bidirectional digital serial port from which it is wired 14 to a bidirectional format converter, such as an RS-232 to RS-485 converter 16. In the exemplary configuration 10, this drives a differential digital line 18 coupling the PC 12 to at least one annunciator 20. The differential digital line 18 may in some embodiments connect to a booster 22, which in the exemplary configuration 10 comprises a pair of bidirectional RS-485 transceivers, and through which an extended differential digital line 24 may connect to at least one extended annunciator 26. Further descriptions of the exemplary configuration 10 and alternatives thereof, can be found in the incorporated U.S. patent application Ser. Nos. 10/664,911 and 10/722,096 and, therefore, are not further discussed herein.

It should be appreciated that the exemplary configuration 10 illustrated in FIG. 1 can use a PC 12 or any similarly-functioning device to command multiple annunciators 20 and/or SPs 28 and/or DESAs 32. Therefore, configuration options for annunciators 20 can be extensive, and the command sequence required to set up a large number of annunciators 20 into a functional system configuration can be substantial in extent and complexity. Automating such a configuration task will, in a large or complex system, significantly reduce time and potential for error.

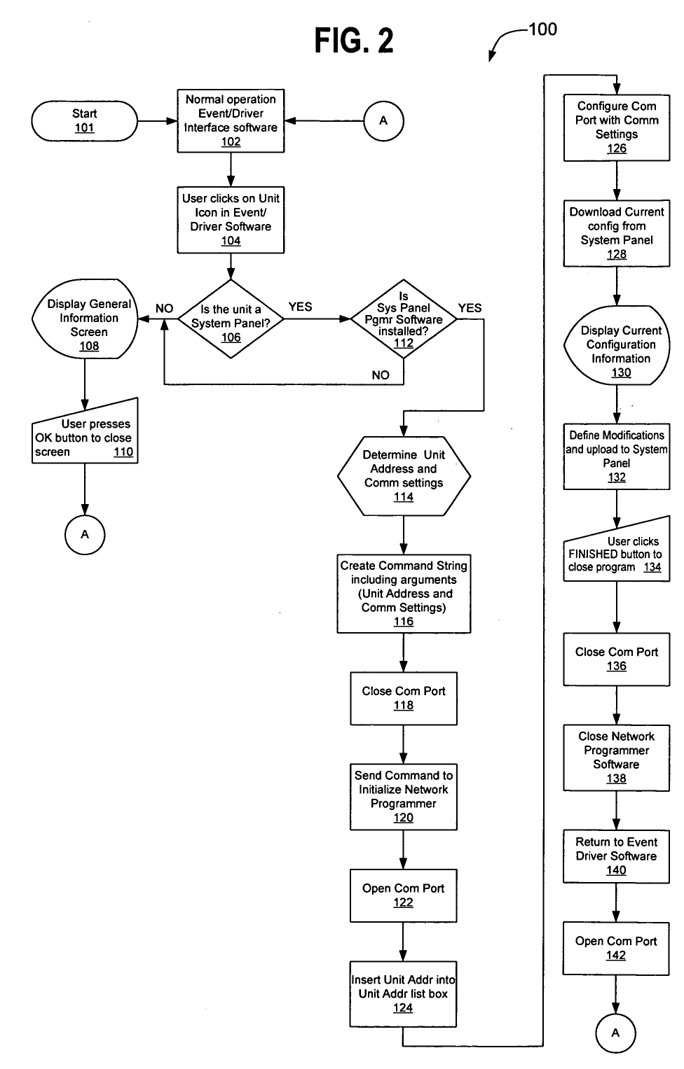

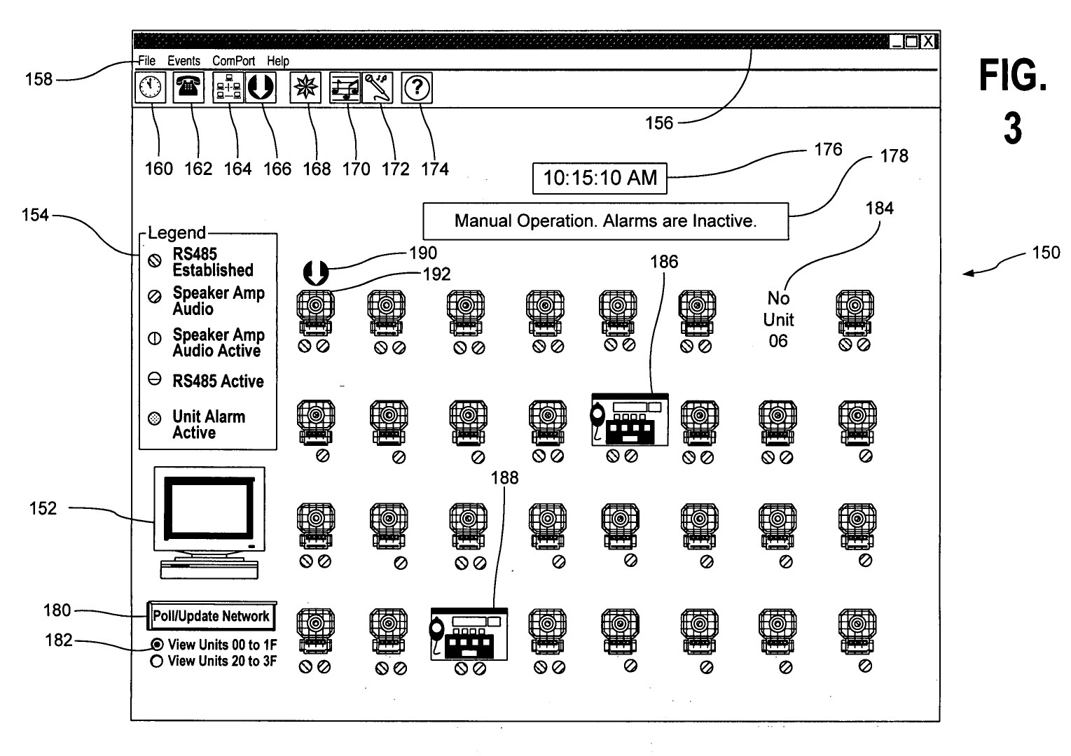

FIG. 2 illustrates a flowchart showing an exemplary process 100 for configuring a system, such as shown in FIG. 1, that can comprise a large number of annunciators, speaker amplifiers, and system panels. The exemplary process 100 begins with initialization at step 101. Presuming a normal initialization or start-up, the exemplary process 100 proceeds to step 102 where a normal operation state is entered and Event/Driver Interface procedures are loaded. At the completion of step 102, the user is presented with a menu of icons for each of the Event/Driver options loaded. Before proceeding, it should be noted that the event/driver moniker used herein signifies a series of operations that can be invoked by user selection. Upon invocation, a drive signal is generated that stimulates a hardware response as a result of the event request. The hardware response can be any function or action. As an example of such a response, in the context of an annunciator system, the event request may result in the generation of an audible tone in an annunciator. Other hardware responses may include, for example, the initiation of display screens as discussed below in FIGS. 3-5.

From step 102, the user is prompted to select from a pane of icons corresponding to an annunciator, speaker amplifier, system panel, or other applicable device or action. Upon selection of an icon by the user at step 104, the exemplary process 100 proceeds to step 106 where the selected icon or unit is tested to determine whether the selected icon or unit is a system panel. If, at step 106, it is determined that the selected icon/unit is not a system panel, then the exemplary process 100 proceeds to step 108 where a general information screen is shown, indicating that modification of such a icon/unit is not possible. In this event, recall and display of data previously acquired may represent the maximum possible support. From step 108, the system can remain in the general information display state or can wait for a response by the user which will return the exemplary process 100 to step 102.

If, however, step 106 determines that the icon/unit selected in step 104 is a system panel, then an inquiry is made in step 112 to verify that the system panel programmer process is installed. If step 112 determines that the system panel programmer process is not installed, then the exemplary process 100 jumps to step 108, displaying the general information. If step 112 determines that the system panel programmer process is installed, then the exemplary process 100 proceeds to step 114, where the appropriate unit address and communication setting are determined. This can be accomplished by recovering the address and communications settings for the selected unit or system panel from configuration storage.

From step 114 the exemplary process 100 proceeds to step 116 where a command string is generated including address and communication setting arguments to invoke the system panel programmer process. From step 116, the exemplary process 100 evaluates communication ports and closes such ports—applicable to hardware systems in which the port is so engineered that it cannot sustain multiple simultaneous unit—in step 118. Next, in step 120 a command to initialize the network programmer function is sent. Following step 120, the exemplary process 100 reopens communications port(s) in step 122 if the communication port(s) are previously closed. Next, in step 124, a target unit address is inserted into an address list box. This is the same address inserted into the command string in step 116, here applied to a different function within the exemplary process 100 implementation. From step 124, a configuration command, in step 126, is sent to the communications port, where the configuration command can be determined at the time of system assembly, or can vary with the required function. From step 126, the target address is polled in step 128, that is, a request for configuration data download is transmitted (for example, to a System Panel), then downloaded as a record.

Next, in step 130, the downloaded configuration data from the target address polled in step 128 is parsed, formatted and displayed to the user. From step 130, the exemplary process 100 proceeds to step 132 where modifications, as needed or as per revised unit requirements, are defined and thereafter uploaded to the selected unit or System Panel.

When the exemplary process 100 has performed the above steps, the user may be prompted at step 134 to finish the editing session with regard to the selected unit/device. When the user indicates completion, by clicking a FINISH button, for example, the exemplary process 134 begins a sequence of house keeping functions.

The house keeping functions may include closing any open communications port (step 136), if required. Next, the network programmer process is closed or idled in step 138. From step 138, preparation to return to the beginning of exemplary process 100 is made by reactivating the event driver process in step 140. After reactivation, in step 142 the exemplary process 100 reopens any necessary communications port. From step 142, the exemplary process 10 jumps to node A which begins the exemplary process 100, if so desired.

The core functions of the above-describe steps integrate procedures into a user-supportive, coordinated system. The exemplary process 100 provides functions that enable access to a second existing process entity from a first one, and allow configuration information to be passed between process entities. It should be appreciated that the exemplary process 100 may be readily implemented in software for execution by the controller or PC 12 of FIG. 1, for example. While the exemplary process 100 details a sequence of steps for obtaining the desired function, it should be appreciated by one of ordinary skill in the art, that as a software implementable process, various steps may be obviated, depending on design or functional preference. For example, in step 114 some selected units may have configuration and/or communication settings embedded in hardware, which may be polled by the exemplary process 100, before generating the command string of step 116. Therefore, modifications to the steps, including deleting some steps, as well as adding additional steps which result in the desired function may be made to the exemplary process 100 without departing from the spirit and scope of this invention.

FIG. 3 is a screen shot 150 illustrating an exemplary presentation on the PC 12 display of FIG. 1 after initialization. This presentation includes an icon for the PC 152 itself, a legend panel 154, an icon for each installed device in the system, a top bar 156, a pulldown menu bar 158, and convenience items, such as “tool bar” icons 160-174, a clock 176, an advisory field 178, a polling request button 180, and a set of group selection “radio buttons” 182 in Microsoft® Windows® parlance. It will be understood that alternative, that is, non-“Windows®”, terminology and alternative graphical representations, can produce similar results, although, for clarity, a single terminology is employed herein. The screen shot 150 includes an array of devices, where all except “Unit06” 184 exist in the system and all are annunciators or speaker amplifiers except “Unit0C” 186 and “Unit1A” 188, which are shown as System Panels (reference number 28 in FIG. 1). The existence of two cluster-selection radio buttons 182 indicates that the screen shown is one of two in the exemplary hardware configuration, where each screen can display status for as many as thirty-two devices in a cluster. Alternative layouts can be established that can show other numbers of devices at one time, suggest physical locations of individual devices by icon position, or otherwise enhance a display. An arrow 190, shown above a “Unit00” annunciator 192, can serve as a flag that a polling result has indicated that this device, identified in a configuration table, has failed to respond correctly, and may require servicing.

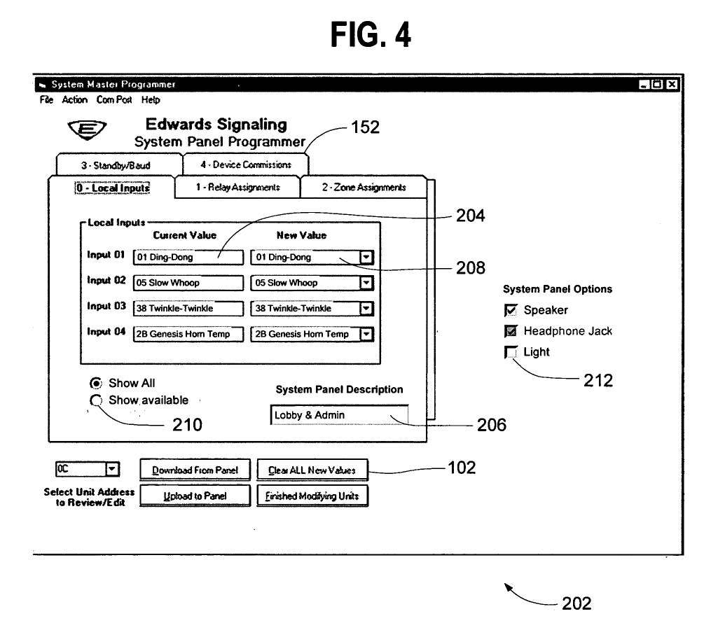

FIG. 4 is a second screen shot 202 showing an exemplary presentation after the user has initiated a status request on a Unit0C SP 186 by a selection sequence. Here, the exemplary presentation indicates that the Unit0C SP 186 has been selected for examination or modification and has initiated operation of the Network Programmer process 120 of FIG. 2 in order to acquire and display Unit0C SP 186 configuration data.

FIG. 4 shows a full-screen display 202. This display 202 initially presents the existing configuration for the Unit0C SP 186. The PC 152 can display a stored copy of the configuration of the Unit0C SP 186, or, in a preferable mode of operation, can use the exemplary processes represented in FIG. 2 to poll the selected unit, acquiring the present configuration of the Unit0C SP 186, then display the freshly acquired data, meanwhile validating the new data against the stored version to confirm system integrity. The display 202 of FIG. 4 is optional, and can be replaced by any other display format that provides similar information.

FIG. 4 further illustrates that some items in the configuration listing for the Unit0C SP 186 can be fixed 204, while other items 206 can be altered by entering revised content, such as from a keyboard, and still other items can be selected from pulldown menus 208. Further selection methods are possible in Windows® parlance, such as radio buttons 210, typically employed for either/or options, and check boxes 212, typically used where multiple items may be selected independently of each other.

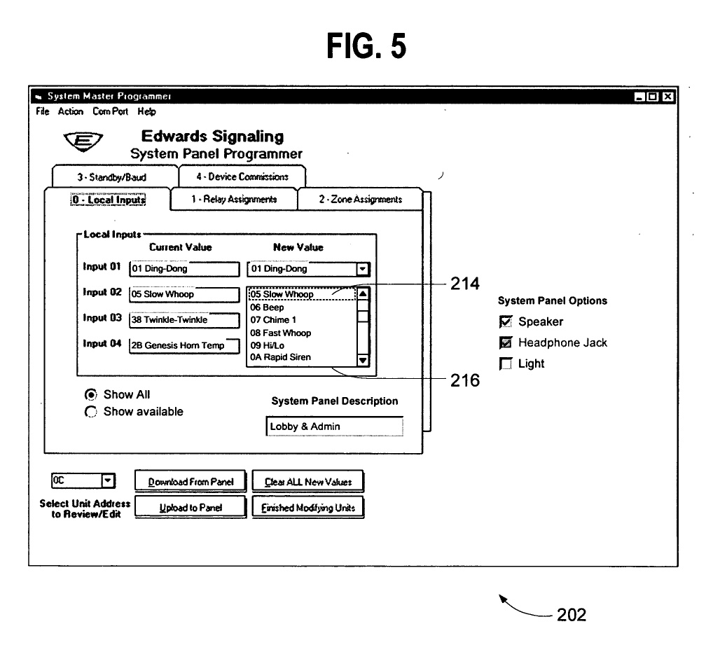

FIG. 5 is a third screen shot following selection of a pulldown list in FIG. 4. In this example, one of the menus of FIG. 4 has been used to select a tone to be sounded by annunciators in response to contact closure on Input 02. The selected tone 214 is one of several on a pulldown menu 216. Once a single entry has been selected in the exemplary system, the pulldown menu 216 can close, leaving the overall system as shown in FIG. 4.

It should be appreciated that the exemplary systems and processes discussed herein may be used for fire-rated systems as well as non-fire-rated systems. The core functionality of the inventive concept herein is, however, independent of fire rating in a public address system. The core concept calls for the use of a simplified and self-evident human interface to minimize error and effort. The concept illustrated in the exemplary system can be enhanced physically and in software to meet requirements for fire safety certification, such as maintenance of full functionality while external power is unavailable, resistance of a fully assembled system to high temperatures for a specified time, and isolation of all control elements from electronic penetration and tampering. These performance requirements may be met by providing a fire-resistant enclosure for the PC 12, including fault-tolerant display and keyboard interfaces, by providing a battery backup system with sufficient capacity to meet certification agency standards, and by using plenum-rated direct wiring between all system elements. These or similar enhancements may be sufficient to earn a fire rating for a system incorporating the invention.

It should be appreciated that a personal computer 12 employed as a controller is one of a substantially unlimited number of computational devices able to support the exemplary process. Such devices feature support for computation, read-write memory, nonvolatile data file storage, and input-output functions, including a visual display capable of supporting a graphical user interface (GUI)-based, continuously active operating system (OS), a keyboard capable of data entry, a pointing device such as a mouse, and a bidirectional communication device—in the exemplary instance, a serial port supporting standard RS-232 input-output data rates and waveforms. Equivalent devices, such as single-board computers affixed within rack-mount or panel-mount cases, can be made compatible with equivalent GUI environments and thus made compatible with the exemplary process with no adaptation. Other types of computational apparatus can likewise support the present exemplary process with minor adaptation to accommodate other operating systems or to operate as a stand-alone process in a non-GUI or minimal-OS environment.

References to use of the differential signal transmission technology RS-485 herein are provided for illustrative purposes, as contemporary commercial devices employing this technology are well known in the art. Other digital-based communications technologies, such as Ethernet®, for example, are less well established in the immediate field of public address systems, but may be entirely suitable for use in this field.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of performing configuration modification on an integrated annunciator and control system, comprising the steps of:
activating an event/driver interface process;
selecting a unit to be modified;
confirming that the selected unit is a system panel;
determining the selected unit's address and communication setting;
creating a command string for the unit address and communication setting;
sending the command string to initialize a network programmer function;
inserting a target unit address based on the network programmer function into an address list box;
sending a configuration command to an opened communications port, the communication port being connected to a target;
polling the target having the target unit address;
downloading configuration data from the polled target;
modifying and uploading to the selected unit the downloaded configuration data; and
closing the network programming function.

2. The method of performing configuration modification on an integrated annunciator and control system of claim 1, further comprising the steps of:
closing the communications port for a first time to terminate normal operation preparatory to initiating an editing session for a target configuration data record; and
reopening the communications port for a first time to establish communications during an editing session for a target configuration data record.

3. The method of performing configuration modification on an integrated annunciator and control system of claim 1, further comprising the steps of:
closing the communications port for a second time following completion of an editing session for a target configuration data record;
reactivating the event driver process; and
reopening the communications port for a second time in support of the event driver process following completion of an editing session for a target configuration data record.

4. A computer readable medium with program instructions for managing an integrated annunciator and control system, comprising the instructions for:
activating an event/driver interface process;
selecting a unit to be modified;
confirming that the selected unit is a system panel;
determining the selected unit's address and communication setting;
creating a command string for the unit address and communication setting;
sending the command string to initialize a network programmer function;
inserting a target unit address based on the network programmer function into an address list box;
sending a configuration command to an opened communications port, the communications port being connected to a target;
polling the target having the target unit address;
downloading configuration data from the polled target;
modifying and uploading to the selected unit the downloaded configuration data; and
closing the network programming function.

5. The computer readable medium with program instructions for managing an integrated annunciator and control system of claim 4, further comprising the instructions for:
closing the communications port for a first time to terminate normal operation preparatory to initiating an editing session for a target configuration data record; and
reopening the communications port for a first time to establish communications during an editing session for a target configuration data record.

6. The computer readable medium with program instructions for managing an integrated annunciator and control system of claim 4, further comprising the instructions for:
closing the communications port for a second time following completion of an editing session for a target configuration data record;
reactivating the event driver process; and
reopening the communications port for a second time in support of the event driver process following completion of an editing session for a target configuration data record.

7. An integrated annunciator and control system, comprising:
a processing device;
a first system monitor and control unit;
a first bidirectional communication system interconnecting said processing device and said system monitor and control unit;
a first signaling device;
a second bidirectional communication system interconnecting said system monitor and control unit and said first signaling device; and
a processor-based instruction sequence actuating said processing device to provide control of said first system monitor and control unit and said first signaling device.

8. The integrated annunciator and control system of claim 7, further comprising:
a first procedure within said processor-based instruction sequence to acquire system status information.

9. The integrated annunciator and control system of claim 7, further comprising:
a second procedure within said processor-based instruction sequence that invokes execution of a third procedure within said processor-based instruction sequence, wherein said third procedure accepts parameters passed from said second procedure as arguments.

10. The integrated annunciator and control system of claim 9, wherein said third procedure within said processor-based instruction sequence further comprises invocation of the transmission of a first command directed to said first system monitor and control unit, wherein said first command specifies a setup configuration for said first system monitor and control unit.

11. The integrated annunciator and control system of claim 7, further comprising:
a fourth procedure within said processor-based instruction sequence, which fourth procedure generates modifications to a previously existing system setup configuration.

12. The integrated annunciator and control system of claim 11, wherein said fourth procedure within said processor-based instruction sequence further comprises a command to said processing device to transmit signals to said first system monitor and control unit, which signals effect a modification to a previously existing system setup configuration within said first system monitor and control unit.

13. The integrated annunciator and control system of claim 7, wherein said processing device further comprises:
a nonvolatile data storage unit;
a nonvolatile instruction storage unit; and
a data and instruction storage and retrieval subsystem supporting said nonvolatile data storage unit and said nonvolatile instruction storage unit.

14. The integrated annunciator and control system of claim 7, wherein said processing device further comprises:
a bidirectional digital communication interface; and
an instruction processor capable of executing instructions retrieved from said nonvolatile instruction storage unit and further capable of executing instructions received through said bidirectional digital communication interface.

15. The integrated annunciator and control system of claim 7, wherein said processing device further comprises:
a data display subsystem;
a keyboard-type data entry subsystem; and
a pointing device subsystem capable of selecting individual items displayed on said data display subsystem.

16. The integrated annunciator and control system of claim 7, wherein said first system monitor and control unit further comprises:
a first system monitor and control unit bidirectional digital communication interface;
a first system monitor and control unit command execution subsystem capable of decoding and executing commands received by said first system monitor and control unit by way of said bidirectional digital communication interface;
a first system monitor and control unit command generator capable of forming instructions to command said first signaling device; and
a first system monitor and control unit command transmitter capable of transmitting commands from said first system monitor and control unit command generator by way of said first system monitor and control unit bidirectional digital communication interface to said first signaling device.

17. The integrated annunciator and control system of claim 7, wherein said first system monitor and control unit further comprises a bidirectional RS-485 interface.

18. The integrated annunciator and control system of claim 7, wherein said first system monitor and control unit further comprises a bidirectional Ethernet® interface.

19. The integrated annunciator and control system of claim 7, wherein said first system monitor and control unit further comprises:
a first system monitor and control unit analog audio signal input port;
a first system monitor and control unit analog audio signal buffer amplifier; and
a first system monitor and control unit analog audio signal output port.

20. The integrated annunciator and control system of claim 7, wherein said first system monitor and control unit further comprises:
a first system monitor and control unit switch closure input port.

21. The integrated annunciator and control system of claim 7, wherein said first system monitor and control unit further comprises:
a first system monitor and control unit relay contact closure output port.

22. The integrated annunciator and control system of claim 7, wherein said first signaling device further comprises:
a first signaling device bidirectional digital communication interface;
a first signaling device command execution subsystem capable of decoding and executing commands received by said first signaling device by way of said first signaling device bidirectional digital communication interface;
a first signaling device reply generator capable of forming reply messages to said first system monitor and control unit; and
a first signaling device reply transmitter capable of transmitting reply messages from said first signaling device reply generator by way of said first signaling device bidirectional digital communication interface to said first system monitor and control unit.

23. The integrated annunciator and control system of claim 7, wherein said first signaling device further comprises:
a first signaling device acoustical output generator.

24. The integrated annunciator and control system of claim 7, wherein said first signaling device further comprises:
a first signaling device analog audio input port;
a first signaling device analog audio amplifier; and
a first signaling device loudspeaker.

25. An integrated annunciator and control system, comprising:
processing means for processing computational information;
first emitting means for emitting acoustic signals;
first monitoring and controlling means for monitoring and controlling said first emitting means;
first communicating means for communicating between said processing means and said first monitoring and controlling means;
second communicating means for communicating between said first monitoring and controlling means and said first emitting means; and
controlling and actuating means for controlling and actuating said first communicating means and said first emitting means.

26. The integrated annunciator and control system of claim 25, further comprising:
acquiring means for acquiring system status information; and
invoking means for invoking execution of a parameter-passing command transmission.
